(19) United States
(12) Patent Application Publication
(10) Pub. No.: US 2012/0020127 A1
(43) Pub. Date: Jan. 26, 2012

(54) POWER SYSTEM WITH POWER SAVING FUNCTION

(75) Inventors: Yao-Hwa Chen, Taipei City (TW); Min-Hua Hsu, Taipei City (TW); Chun-Sheng Hsueh, Taipei City (TW)

(73) Assignee: ASUSTEK COMPUTER INC., Taipei City (TW)

(21) Appl. No.: 13/185,519

(22) Filed: Jul. 19, 2011

(30) Foreign Application Priority Data
Jul. 22, 2010 (TW) 99124213

(51) Int. Cl. H02M 7/04

(52) U.S. Cl. 363/74

(57) ABSTRACT

A power system includes an electronic device having a host and a state generator and an adaptor. The host is capable of presenting a plurality of states and generating a plurality of state signals corresponding to the states, and the state generator is electrically connected to the host, receives the state signals and generates a control signal accordingly. The adaptor is connected to an AC voltage and has a state receiving terminal to receive the control signal. The adaptor is capable of generating a DC voltage to the electronic device according to the control signal.

### CROSS-REFERENCE TO RELATED APPLICATION

This application claims the priority benefit of Taiwan application serial no. 99124213, filed Jul. 22, 2010. The entirety of the above-mentioned patent application is hereby incorporated by reference herein and made a part of this specification.

### BACKGROUND OF THE INVENTION

1. Field of the Invention

The invention relates to a power system and, more particularly, to an adaptor which supplies power to an electronic device according to whether the electronic device has a battery or not or the operation state of the electronic device.

2. Description of the Related Art

FIG. 1 is a schematic diagram showing that a conventional adaptor 12 supplies power to an electronic device 10 (such as a notebook computer, a mobile phone or a digital camera). The electronic device 10 mainly includes a host 102 and a battery 104, and the battery 104 is a chargeable battery. The adaptor 12 is connected to an alternating current (AC) voltage to receive the AC voltage AC_in, and the adaptor 12 is connected to the electronic device 10 to supply a direct current (DC) voltage DC_in to the electronic device 10.

As long as the conventional adaptor 12 is connected to the AC voltage, the adaptor 12 supplies the DC voltage DC_in to the electronic device 10 continuously regardless of the state of the host 102 and whether the battery 104 is fully charged or not, resulting in an power waste in the electronic elements of the adaptor 12.

For example, when the electronic device 10 is not configured with the battery 104, and the host 102 is at a power off state, once the adaptor 12 is connected between the AC voltage and the electronic device 10, the conventional adaptor 12 keeps supplying a constant DC voltage DC_in to the host 102, resulting in the power waste.

When the electronic device 10 is not configured with the battery 104 and the host 102 is at a hibernation state or a sleep state, once the adaptor 12 is connected between the AC voltage and the electronic device 10, the conventional adaptor 12 still keeps supplying the constant DC voltage to the host 102.

In general, when the host 102 is at different states (a standby state, a hibernation state, a sleep state, an operation state, or other states), the needed minimum voltages are different. However, the conventional adaptor 12 still supplies the constant DC voltage DC_in to the host 102, resulting in the power waste.

Similarly, when the electronic device 10 is configured with the battery 104 and the host 102 is at the power off state, once the adaptor 12 is connected between the AC voltage and the electronic device 10, the adaptor 12 keeps supplying the DC voltage to the electronic device 10 for charging the battery 104. However, when the battery 104 is fully charged, the adaptor 12 still keeps supplying the DC voltage DC_in to the host 102, which also results in the power waste.

Moreover, the method of using a charger of the conventional adaptor to charge the battery may also waste the power. FIG. 2 is a schematic diagram showing that the charger 14 (such as a mobile phone or a digital camera charger) of the conventional adaptor charges a battery 104. As shown in FIG. 2, once the adaptor 12 is connected between the AC voltage and the battery 104, even if the battery 104 is fully charged, the adaptor 12 still keeps supplying power to the battery 104, also resulting in the power waste.

In sum, no matter the host is at the power off state or the standby state (the hibernation state, the sleep state, the operation state or other states), or whether the battery is fully charged or not, the conventional adaptor keeps supplying a constant voltage to the electronic device at the standby state, resulting in the power waste.

### BRIEF SUMMARY OF THE INVENTION

An adaptor with power saving function is provided. It adjusts the adaptor voltage supplied to an electronic device according to whether the electronic device has a battery, an operation state of the electronic device and whether the battery is fully charged or not, which saves power.

A power system including an electronic device and an adaptor is provided. The electronic device includes a host, a state generator. The host has a plurality of states and generates a plurality of state signals corresponding the plurality of states. The state generator is electrically connected to the host, receives the state signals and generates a control signal according to the state signals. The adaptor is connected to an AC voltage and has a state receiving terminal to receive the control signal. The adaptor generates a DC voltage to the electronic device according to the control signal.

Since the power system includes the adaptor and the state generator, the state generator adjusts the voltage supplied to an electronic device according to whether the electronic device has a battery, the operation state of the electronic device and whether the battery is fully charged or not, which saves power.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing that a conventional adaptor supplies power to an electronic device.

FIG. 2 is a schematic diagram showing that a charger of a conventional adaptor charges a battery.

FIG. 3 is a schematic diagram showing that an adaptor is applied to an electronic device without a battery installed in an embodiment of the invention.

FIG. 4 a schematic diagram showing that an adaptor is applied to an electronic device with a battery installed in an embodiment of the invention.

FIG. 5 is a chart showing control signals Va outputted by a state generator and corresponding voltages DC_in outputted by an adaptor when an electronic device operates at different states in an embodiment of the invention.

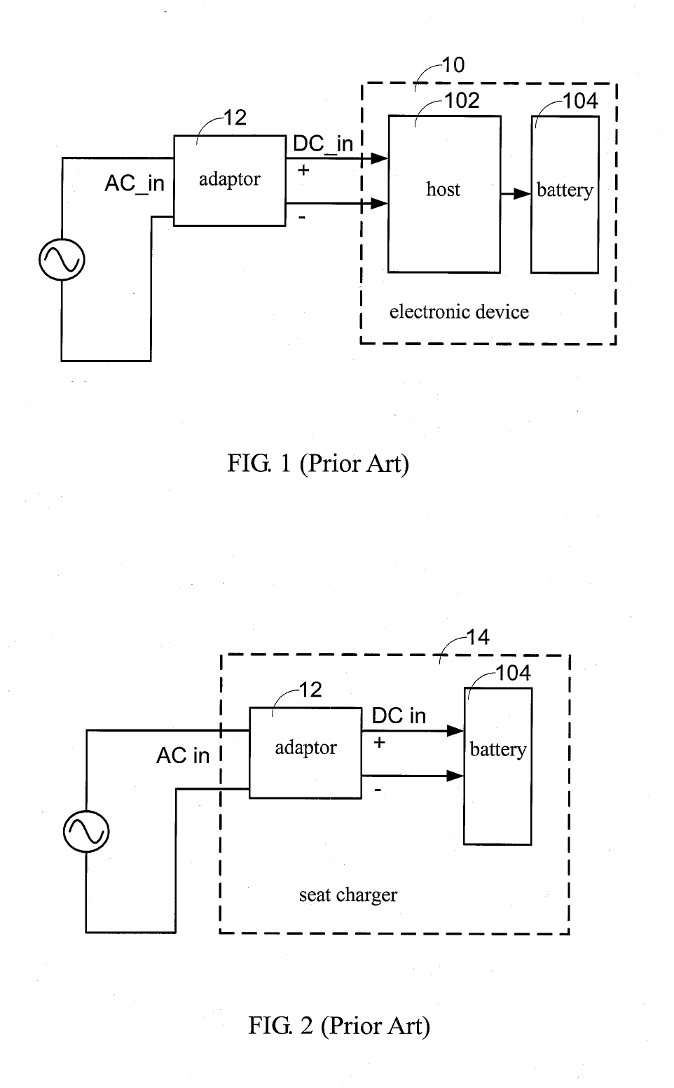

### DETAILED DESCRIPTION OF THE EMBODIMENTS

The electronic device further includes a state generator. The state generator adjusts the power supplied to an electronic device according to whether the electronic device has a battery, an operation state of the electronic device and whether the battery is fully charged or not, which saves power.

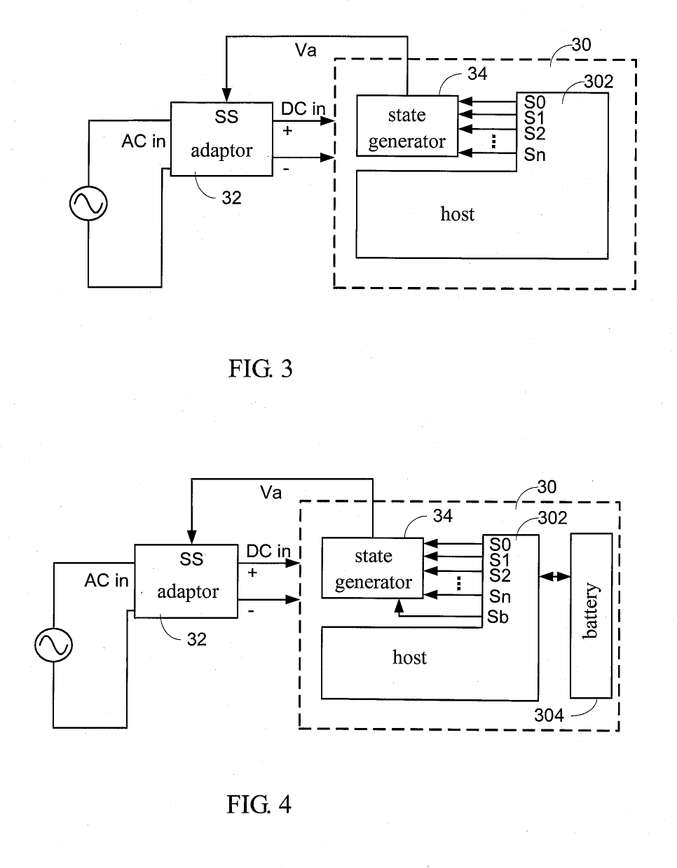

FIG. 3 is a schematic diagram showing that an adaptor is applied to an electronic device without a battery installed. An electronic device 30 includes a host 302 and a state generator 34. An input end of the adaptor 32 is connected to an input AC AC_in, and an output end of the adaptor 32 is connected to the electronic device 30 to supply a DC voltage DC_in to the electronic device 30. Furthermore, the adaptor 32 includes a state receiving terminal SS for receiving a control signal Va. According to an embodiment of the invention, the state generator 34 outputs the control signal Va to the state receiving terminal SS of the adaptor according to the operation state of the host 302, and the adaptor 32 adjusts the DC voltage DC_in supplied to the host 302 according to the received control signal Va.

For example, when the state generator 34 detects that the host 302 is at a SO state (such a power off state), since the electronic device 30 is not configured with a battery, it does not need to supply power to the battery. The state generator 34 outputs the control signal Va (which equals to V0) to the state receiving terminal SS of the adaptor 32 to cut the power of the adaptor 32 off, which means that the DC voltage DC_in supplied by the adaptor 32 to the electronic device 30 is 0V. Thus, when the electronic device 30 is not configured with the battery and the host 302 is at the S0 state (such as the power off state S0), the power of the adaptor 32 is cut off completely, and the adaptor 32 consumes no power at the moment.

Moreover, when the state generator 34 detects that the host 302 operates at a S1 state (such as a hibernation state), the state generator 34 outputs the control signal Va (which equals to V1) to the state receiving terminal SS of the adaptor 32 to make the DC voltage (DC_in) outputted by the adaptor 32 to the electronic device 30 be the first voltage DC1. The first voltage DC1 is the minimum voltage needed by the electronic device 30 when it operates at the S1 state (such as the hibernation state). Consequently, the adaptor 32 saves power.

Similarly, when the state generator 34 detects that the host 302 operates at other states (S2 to Sn, such as a standby state, a sleep state, and an operation state), the state generator 34 outputs the corresponding control signal Va (which is one of V2 to Vn) to the state receiving terminal SS of the adaptor 32 to make the DC voltage DC_in outputted by the adaptor 32 to the electronic device 30 be the corresponding voltage DC2 to DCn. Thus, the adaptor 32 generates the corresponding voltage to the electronic device according to the state of the host 302 of the electronic device 30, and the power saving function of the adaptor 32 is achieved.

FIG. 4 a schematic diagram showing that an adaptor is applied to an electronic device with a battery installed. When the state generator 34 detects that the electronic device 30 is configured with a battery, and the state generator 34 detects that the electronic device 30 operates at the battery state Sb, the state generator 34 outputs the control signal Va (which equals to Vb) to the state receiving terminal SS of the adaptor 32 to make the DC voltage DC_in outputted to the electronic device by the adaptor 32 be a charging voltage DC_IN (which equals to DC). Generally, the charging voltage DC is the maximum voltage outputted by the adaptor 32 to make the battery 304 fully charged under the charging voltage DC in the shortest time.

Once the battery 304 is fully charged, the state generator 34 acts according to the other state signals S0 to Sn outputted by the host 302. For example, when the electronic device 30 is at the power off state, but the battery 304 is not fully charged, the host 302 outputs the battery state Sb, the state generator 34 outputs the control signal Va (which equals to Vb) to allow the adaptor 32 to output the maximum voltage DC. When the battery 304 is fully charged, the host 302 outputs the SO state (such as the power off state) immediately, and the state generator 34 outputs the shutdown control signal Va (which equals to V0) to the adaptor 32 to cut the power of the adaptor 32 off completely, and that is, the adaptor 32 does not supply power to the electronic device 30 (DC_in is 0V) at the moment.

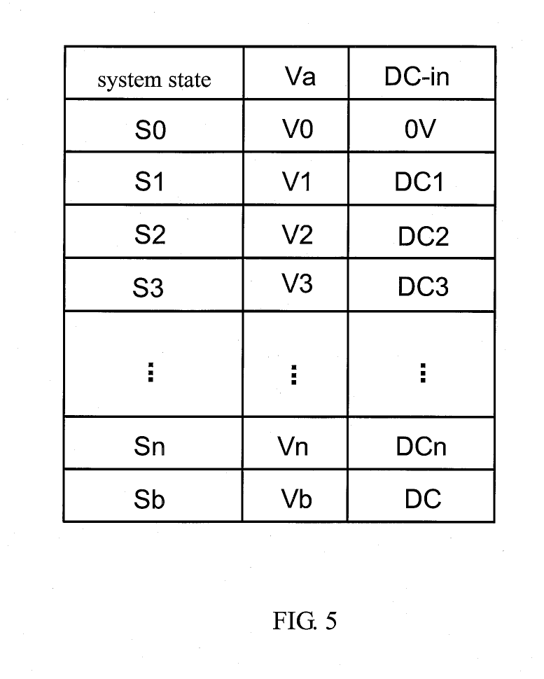

FIG. 5 is a chart showing that control signals Va outputted by a state generator and corresponding voltages DC_in outputted by an adaptor when an electronic device operates at different states. As shown in FIG. 5, when the host 302 operates at different states, the host 302 generates different state signals (S0 to Sn, or Sb) to the state generator 34 to allow the state generator 34 to output the control signal Va to the state receiving terminal SS of the adaptor 32. The adaptor 32 outputs the corresponding output DC voltage DC_in to the electronic device 30 according to the control signal Va.

In sum, in the embodiment, the adaptor adjusts the voltage supplied to the electronic device according to whether the electronic device has a battery, the operation state of the electronic device, and whether the battery is fully charged or not, which saves power.

Furthermore, in the embodiment, the electronic device operates at the power off state, the hibernation state or the sleep state, which is not for limiting the invention, the adaptor may also be applied to the electronic device operating at other states.

In the embodiment, the adaptor is applied to an electronic device such as, but not limited to, a notebook computer, a mobile phone or a digital camera. It may also be applied to a charger, and the operating principle is the same as that of the adaptor applied to the electronic device, which is omitted herein.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A power system, comprising:
an electronic device including:
a host having a plurality of states and generating a plurality of state signals corresponding the plurality of states; and
a state generator electrically connected to the host, receiving the state signals and generating a control signal according to the state signals; and
an adaptor connected to an alternating current (AC) voltage and including a state receiving terminal to receive the control signal;
wherein the adaptor generates a direct current (DC) voltage to the electronic device according to the control signal.

2. The power system according to claim 1, wherein the state signals includes a power off state, a standby state, a hibernation state, a sleep state, and an operation state of the host.

3. The power system according to claim 2, wherein when the host is at the power off state, the state generator outputs the control signal to the adaptor to make the DC voltage be 0V.

4. The power system according to claim 1, wherein the electronic device further includes a battery electrically connected to the host.

5. The power system according to claim 4, wherein before the battery is fully charged, the host outputs a battery state signal to the state generator to make the state generator output the control signal to control the adaptor to generate the DC voltage.

6. The power system according to claim 5, wherein the DC voltage generated by the adaptor under a control of the control signal is a maximum DC voltage.
